(19) United States
(12) Patent Application Publication
(10) Pub. No.: US 2007/0169603 A1
(43) Pub. Date: Jul. 26, 2007

(54) Hole punch

(76) Inventor: Joel S. Marks, Sherman Oaks, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/336,300

(22) Filed: Jan. 20, 2006

(51) Int. Cl. B26F 1/14

(52) U.S. Cl. 83/605; 83/686; 83/687

(57) ABSTRACT

A hole punch having one or more punch elements located above a base and having substantially upward opening slot(s) to hold a stack of papers or sheet media to be punched, and an L-shaped handle pivoting at the elbow in the L on the base, wherein one or more of the handle connectors extend in between, underneath, or along the outside of the punch elements. The punch elements include a horizontally translating punch pin having a notch hooked by an actuating end of the pivoting handle to produce the punching action.

### FIELD OF THE INVENTION

The present invention relates to hole punches. More precisely, the present invention relates to a paper or sheet media hole punch with a sheet slot oriented in a generally vertical position.

### BACKGROUND OF THE INVENTION

A hole punch device is used to create holes in one or more sheets of paper or other thin material. A punch pin is movable through the papers into a die hole to cut one or more holes in papers. Commonly the paper slot extends horizontally whereby the papers are inserted horizontally, for example parallel to a table top. In other designs the slot extends downward, for example toward a table top. The papers are moved down into the slot for punching. The pin moves horizontally. In a manually actuated punch a handle links through a support structure to the pin. The linkage should provide leverage so that a reasonable force upon the handle creates a large cutting force at the pin.

In any punch device, it is desirable that the device be compact to fit conveniently on a desktop. However the handle should move a large enough distance to provide the required leverage.

Prior vertical entry hole punches include the disclosure of U.S. Pat. No. 4,077,288 (Holland). Guide opening, or slot, 48 extends vertically. Pin 20 extends horizontally from the slot toward operating bar, or handle, 50. Handle 50 is hinged on the same side of slot 48 that the handle is pressed. U.S. Pat. No. 3,921,487 (Otsuka et al.) shows another non-horizontal entry punch. Slot 14 extends downward at an angle. Handle 30 is hinged behind the slot and pressed from in front of the slot. The handle has an extended, bent cantilevered bar. The pressing area and the hinged area of the handle are connected by a bar segment that extends across one side of the paper slot region. Such a bar must be of heavy construction to prevent flexing in use. U.S. Pat. No. 6,688,199 (Godston et al.) shows a vertical entry punch with a handle geometry similar to Otsuka '487, but with a more complex linkage between the handle and the pin.

In a manually actuated device such as a hole punch, a simply hinged handle should ideally have a handle length that locates the pressing area as far as possible from a hinge location of the handle. In this manner, a large motion of the pressing area causes a minimal angular change of the handle, and of course gives the greatest amount of leverage. On the other hand, the great handle length also results in an excess punch size. In addition, the length and girth of a long handle requires that the handle be made from a heavy gauge bar metal to avoid potential buckling in use.

### SUMMARY OF THE INVENTION

In one embodiment of the present invention hole punch, a handle pressing area is positioned opposite the handle hinge, with respect to the paper or sheet media slot. The hinge and pressing area are connected by a structure that extends under the paper slot, preferably at multiple or continuous locations along the paper slot. With multiple connections, or a single continuous connection, the handle may be of sheet metal construction as compared to the heavier bar structure needed in the prior art. The handle preferably has an “L” shape profile that maximizes work efficiency and fits in between and/or underneath the punch elements so the overall width and/or height dimensions of the hole punch device remain compact.

### BRIEF DESCRIPTION OF THE DRAWINGS

FIG. 1 is an end view of a vertical entry punch in a rest position.

FIG. 2 is the punch of FIG. 1 in a pressed position.

FIG. 3 is a perspective view of an assembly including a punch element, a pin, and a spring.

FIG. 4 is a perspective view of a pin.

FIG. 5 is an end view of an alternative embodiment vertical entry punch.

FIG. 6 is a top plan view of the punch of FIG. 5.

FIG. 7 is a top plan view of the punch of FIGS. 1-2.

### DETAILED DESCRIPTION OF THE PREFERRED EMBODIMENTS

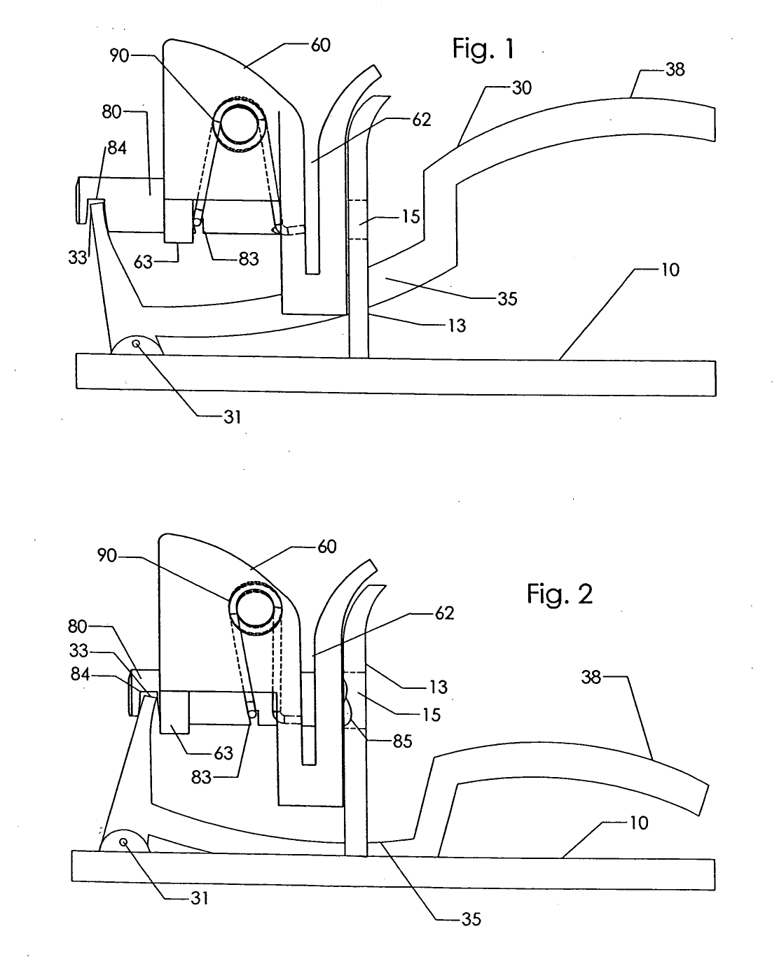

FIG. 1 is an end view of a preferred embodiment vertical entry hole punch. In the side elevational or profile view of FIGS. 1 and 2, base or support structure 10 includes a vertically extending rib 13. Rib 13 generally bisects support structure 10 into halves with a front end and a front half to the left in FIGS. 1-2 and a back half and a back end to the right. In the preferred embodiment shown, support structure 10 is fashioned into a large, flat, stable base.

Punch element 60 is supported on rib 13 with slot 62 extending preferably substantially vertically, or in various alternative embodiments at least partly vertically or at an angle from the vertical. The opening of slot 62 is preferably fairly straight upwards or angled upwards. Punch element 60 is preferably disposed in the front half of support structure 10 toward the front end (to the left in FIGS. 1-2). This balances the forces acting on the punching device since the downward actuating force applied by the user on pressing area 38 is toward the back end of support structure 10. Optionally, punch element 60 may be more directly supported on support structure 10, as in for example by a downward extended portion of punch element 60 in FIGS. 1 and 2 (not shown) that extends into support structure 10.

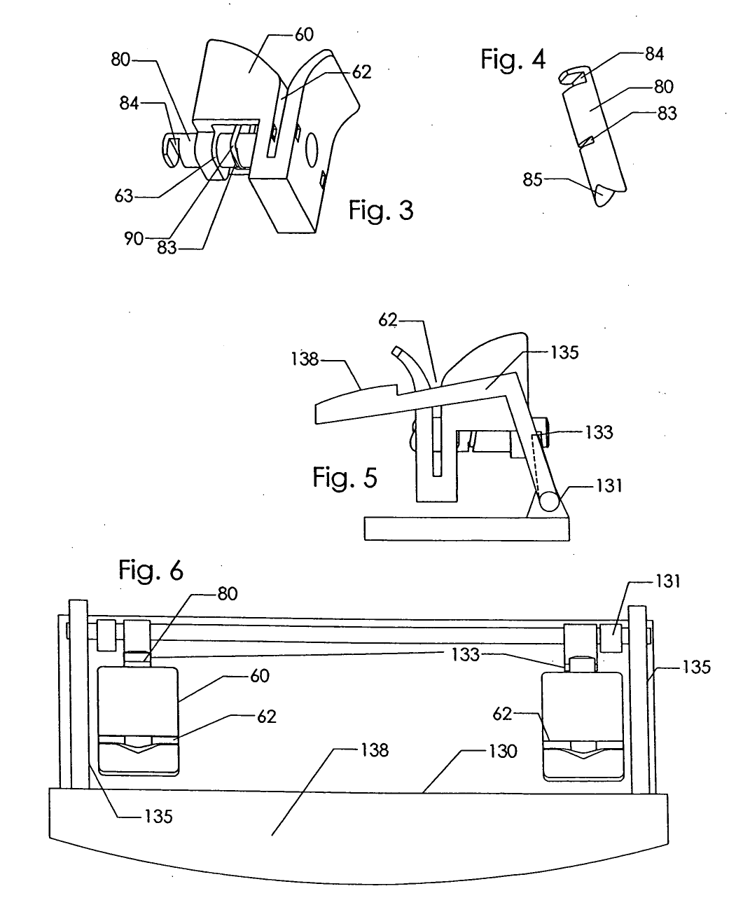

The punch element assembly or like means for hole punching, shown in FIGS. 1-3, may be similar to that disclosed in co-pending U.S. patent application Ser. No. 11/215,423, filed Aug. 30, 2005, titled “Hole Punch Element” by the present inventor, which application is hereby incorporated by reference. In the isolated perspective view of the punch element in FIG. 3, the element 60 has a cylindrical cutting pin 80 passing through a slot 62. Rib 63 and a through hole of the punch element 60 help guide the linear translation of pin 80. A preferred embodiment cutting pin 80 is shown in FIG. 4, which pin has notch 84 at one end to receive actuating end 33 of handle 30. A second notch 83 toward the center of the pin from notch 84 provides an anchoring point for an optional return spring that helps withdrawn pin 80 after the punching stroke. At the opposite end of pin 80 is cutting end 85.

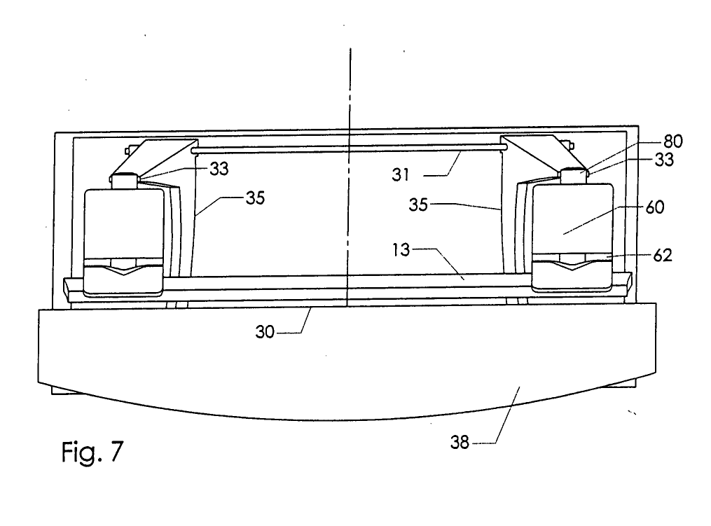

As seen in FIGS. 1-3, cutting pin 80 is slidably fitted to punch element 60. Rib 13 extends along a length of the punch (into the page of FIGS. 1 and 2). Rib 13 may thus support two or more punch elements 60 in a side-by-side arrangement. This is seen in the plan view of FIG. 7.

As seen in FIGS. 1-2, and 7, connector 35 links pressing area 38 to hinge 31. Connector 35 passes through respective one or more openings in rib 13 (not shown). A single elongated or continuous connector 35 may extend along the length of the punch (into the page of FIGS. 1 and 2). Alternatively, each punch element 60 may be associated with one or a group of connectors that pass in between the punch elements, or underneath the punch elements, or any combination thereof. At least one punch element may have connectors 35 passing below and to each side (in and out of the page of FIGS. 1 and 2).

In the preferred embodiment shown in FIG. 7, two spaced connectors or arms 35 of handle 30 pass in between the two punch elements 60. Of course, there can be more or fewer than the two punch elements 60 shown in FIG. 7 with more or fewer respective connectors 35. Optionally, a single connector passes through an elongated slot of rib 13, not shown. For example, connectors 35 of FIG. 7 may be joined by an intermediate bridge structure (not shown) to form a single connector 35. Thus, with connectors 35 passing in between the two outer punch elements 60, the punch device may be fairly narrow and compact across its width. If there are two connectors 35 located on the outside of the two punch elements 60 as in the FIG. 6 embodiment, then the width of each connector 35 has to be added to the overall width of the spaced apart punch elements 60, increasing the overall width of the punch device.

Handle 30 includes pressing area 38 near its distal end, hinge 31 in the form of an axle pivotably mounted to support structure 10 proximate to the front end thereof, and a torque arm extending from pivot 31 and terminating at actuating end 33. The torque arm preferably has a bulked up base proximate to hinge 31 for improved strength. Handle pressing area 38 preferably has a slight convex curvature to improve ergonomics for the user's hand. Furthermore, the preferred embodiment connector 35 of handle 30 in the profile views of FIGS. 1-2 is made from double opposed curves linked by a straight segment. The double opposed curves of single or multiple connector 35 can fit in between punch elements 60 as seen in FIG. 7.

In an alternative embodiment, the double opposed curves of connector 35 correspond to a concave section that fits immediately or at least partially underneath punch element 60 (not shown) and a convex section adjacent the pressing area 38, which curves amplify the range of motion as measured at pressing area 38. To illustrate this broad range of pressing area 38 of either embodiment (i.e., in between or underneath the punch elements), in the rest position of FIG. 1, pressing area 38 is in its highest position well above the longitudinal axis of pin 80, and in the pressed position of FIG. 2, the pressing area 38 is well below the longitudinal axis of pin 80. An optional groove, cut-out, or recess may be formed into the top surface of support structure 10 to further improve the range of motion for handle 30.

Yet despite having a broad range of motion, the convex connector shape near pressing area 38 results in a vertically compact device wherein pressing area 38 despite being in its highest position in FIG. 1 is still below the height of punch element 60. The height is defined as the distance perpendicular to the longitudinal axis of the pin. The concave section of connector 35 again ensures a great range of pivoting action and maintains a vertically compact profile to optionally fit underneath one or more punch elements 60. Even in the embodiment where connector 35 fits in between two punch elements 60, the concave section of connector 35 lowers the center of gravity of the handle since it operates in a space even lower than the bottom of slot 62. Being vertically compact in the punch device helps lower the overall center of gravity and improves stability of the device in operation.

The handle profile shape preferably locates pressing area 38 overlying the back end of support structure 10 very far away from hinge 31 for maximum leverage. When joined to the short torque arm extending from hinge 31 to actuating end 33, handle 30 achieves a large work advantage. To be sure, the preferred embodiment handle has essentially an “L” shape where the approximate 90-degree elbow or bend in the L coincides with hinge 31. The lever arm of the L begins at the elbow or hinge 31 and follows the double opposed curve profile of connector 35 terminating at pressing end 38. The other arm of the L corresponds to the short torque arm of handle 30 beginning at elbow or hinge 31 and terminating at actuating end 33. Thus, the long lever arm (i.e., connector 35) preferably extends substantially from the front end to the back end of support structure 10, as best seen in FIG. 2. As seen in FIGS. 1 and 2, the L shape is approximate; there may be a further extension of the L as shown to facilitate mounting to the base or equivalent structure.

By using the optional L shape handle design, punch element or elements 60 can be placed almost coextensive or at least in an overlying relationship with handle 30. This arrangement results in a very compact hole punch device. Moreover, the great work advantage (i.e., long lever arm with short torque arm) of handle 30 efficiently focuses energy to the cutting pin or pins 80 so the pins have adequate drive to punch through a thick stack of papers or like sheet media. Of course, more than one handle 30 may be used to deliver driving force to multiple punch elements 60.

Now referring to the end views of FIGS. 1-2, the theoretical force vectors act in a clockwise circle starting vertically downward at pressing area 38 and ending at cutting end 85/paper stack/and rib 13. If the force vectors are connected, a generally 270 degree circle can be drawn; that force vector circle generally terminates where the cutting end 85 meets the paper stack which is substantially centered above support structure 10 and not too high off the surface provided by support structure 10 creating a low center of gravity for the punching action. Support structure 10 being centrally located directly beneath this punching action thus supplies a stable base so there is minimal instability even when punching through a thick stack of papers when a great pressing force or impulse is applied by the user. With the low position of the punching action, the longitudinal axis of pin 80 is near to support structure 10. Therefore, the overall structure is stiff with minimal bending or distortion of rib 13 or of punch element 60 secured to or extending from support structure 10.

Positioned above hinge 31 is actuating end 33. Actuating end 33 engages or hooks into notch 84 of cutting pin 80. Handle 30 is preferably made integral and one-piece. Thus, pressing area 38 is directly linked to cutting pin 80 without intervening linkages, minimizing complexity and frictional losses that would otherwise be brought into the action. Actuating end 33 in the preferred embodiment has a generally square end with a slight curvature to the wall that interfaces with notch 84. Notch 84 is similarly shown with square corners and flat walls but may be modified with gentle curves to decrease friction and improve smoothness in the action. In various alternative embodiments (not shown), the notch in the cutting pin can be replaced by a flange, a rib, or a pivoting pin creating the linkage to the actuating end 33. Notch 84 is near a distal end of pin 80 opposite cutting end 85. In this manner, the distance between pressing area 38 and actuating end 33 is maximized in a smallest practical punch device. As discussed elsewhere, this distance reduces angular change at pressing area 38.

An optional return spring 90 is anchored at notch 83 of pin 80 and to the superstructure of element 60. Spring notch 83 is centrally positioned, or at least spaced from, actuating notch 84, between cutting end 85 and the opposite distal pin end. Return spring 90 thus biases pin 80 away from slot 62. A torsion spring is shown, but a compression spring, a tension spring, a bar spring, or the like may be used as well. Although one return spring 90 is shown, none, two or more return springs can be used. Because actuating end 33 hooks into notch 84 of pin 80, if the user lifts on pressing end 38 of handle 30, pin 80 can be withdrawn in the reverse direction (leftward in FIG. 1) from the punching stroke (rightward in FIG. 1). Therefore, return spring 90 may be omitted altogether, or if present, the return spring may have a spring constant that is large enough to just complement the lifting action on handle 30 during the withdrawing stroke. If too high a spring constant is selected for the return spring 90, then the user must overcome this spring force in addition to the force needed to punch the stack of papers or sheet media, which may be undesirable.

Pin 80 is supported at an upper end by rib 63. Rib 63 may include a circular opening corresponding to the outer diameter of pin 80, but other shaped openings including a semicircle or other shape to rotationally orient pin 80 are contemplated.

In use, handle 30 is pressed downward from the position of FIG. 1 to that of FIG. 2. Pin 80 enters slot 62. In the pressed position of FIG. 2, after a user has pushed down on pressing area 38, cutting end 85 of pin 80 has been moved toward opening 15 in rib 13. Cutting end 85 has thus traversed the gap in slot 62 and any paper or sheet media held therein has been punched through. The cut paper chips are ejected out of opening 15.

Preferably, pressing area 38 is located as far as possible from hinge 31, being positioned on opposite sides of slot 62. Elongated (into the page of FIGS. 1 and 2) or multiple connectors 35 allow the use of a lightweight, simple structure for handle 30. For example, handle 30 may be constructed of sheet metal that is stamped or die cast into shape. Or the handle may be made from die cast or injection molded plastic, including reinforced plastic. Fiberglass may also be used to fabricate the handle. Combinations of these materials may be used; for example, a steel actuating end 33 with a polymer structure elsewhere. Since handle 30 requires a large amount of material, yet if the handle material itself is lightweight and sufficiently strong to operate the action, the hole punch benefits overall by having reduced weight for portability.

FIGS. 5 and 6 show an alternative embodiment vertical entry punch with two connecting arms 135 positioned to cross each side of a paper slot, which in this embodiment are slots 62 of punch elements 60. Connectors 135 may cross directly beside, or at least partially above or below slot 62. The action is similar to the embodiments described above. Handle 130 includes pressing area 138, two connecting arms 135 one on each side of the outer punch elements 60, and pivot 131. Actuating end 133 engages pin 80 similar to the action described in the FIGS. 1-2 embodiment. Downward pressure on pressing area 138 translates the cutting pin via actuating end 133 across slot 62 (leftward in FIG. 5). Any papers or sheet media residing in slot 62 are thus punched through. An optional return spring (not shown) arranged similar to the FIGS. 1-2 embodiment helps withdraw the cutting pin from slot 62 (by biasing the cutting pin rightward in FIG. 5).

The two connecting arms 135 provide support to both sides of pressing area 138. There can be more than two connecting arms, of course. As a result of using two or more connecting arms, the structure of handle 130 may be of lighter construction than the cantilevered, single arm shown in conventional design hole punches. That is, the user applied force at pressing area 38 is generally evenly divided among the multiple connecting arms 135 used to drive punch elements 35, which arrangement eliminates a torque component that would otherwise be present in a cantilevered, single connecting arm.

Each arm preferably has an inverted L profile where one end of the L is attached to pivot 131 and the opposite end terminated with pressing area 138. Pivot 131 coincides with an axle, best seen in the plan view of FIG. 6. The pivot/axle 131 fixedly join the two parallel connecting arms 135. Further, a torque arm extending radially from pivot/axle 131 terminates in actuating end 133 which engages the cutting pin. As seen in FIG. 6, the torque arm is not co-linear with connecting arms 135, although they may be parallel as shown. Further, the torque arm and connecting arm 135 both extend radially from pivot/axle 131 which is located at the front edge of the base (toward the right in FIG. 5). Both the torque arm and the connecting arms have generally the same angular orientation, which in FIG. 5 is at about the 11:00 o'clock position in the rest position of connecting arm 135. Optionally, connecting arm 135 may extend horizontally in FIG. 5 and connect to pressing area 138 through a vertical segment. This arrangement would be similar, with respect to connector path of the end view of FIG. 5, to the connector path of FIGS. 1 and 2.

In FIG. 5, the inverted L-shape connecting arm 135 has an upward pointing elbow and has a length that preferably spans the entire length of the base. Pressing area 138 in this embodiment is thus located very far away from pivot/axle 131. Specifically in the embodiment shown, pressing area 138 extends past the back end of the base so the lever arm as measured from pivot/axle 131 to the distal end at pressing area 138 extends past the back end of the base for even greater leverage. The lever arm corresponding to connecting arm 135 is thus very long. The torque arm as measured from pivot/axle 131 to actuating end 133 is again relatively short. Therefore, great work advantage is created by the lever arm/pivot/torque arm arrangement shown in FIG. 5.

Pivot/axle 131 is opposite the paper slot from pressing area 138. Both are preferably and generally parallel to the front and back end of the base. Together with connecting arms 135 and pressing area 138, the structures substantially circumscribe punch elements 60 and slots 62 contained therein. More of fewer punch elements 60 and/or arms 135 may be used. The circumscribing arrangement provides a stable platform during the punching operation.

From the foregoing detailed description, it should be evident that there are a number of changes, adaptations and modifications of the present invention that come within the province of those skilled in the art. However, it is intended that all such variations not departing from the spirit of the invention be considered as within the scope thereof except as limited solely by the following claims.

I claim:

1. A hole punch for punching a hole in sheet media, comprising:
a base having a front end and a back end;
a punch element disposed overlying toward the front end of the base, the punch element including a slot to hold the sheet media;
a cutting pin slidably disposed on the punch element, the pin passing through the slot and the sheet media; and
an L shape handle that is pivotably mounted proximate to the front end of the base at the elbow in the L, wherein the L includes a long lever arm and a short torque arm, and the short arm engages the cutting pin and the long lever arm in its highest-most position does not extend above a height of the punch element.

2. The hole punch of claim 1, wherein the L shape handle includes a pressing end of the long lever arm, and wherein the pivoting elbow of the L is located on one side of the slot of the punch element and the pressing end is located at an opposite side of the slot.

3. The hole punch of claim 1, wherein the long lever arm of the handle includes double opposed curves linked by a straight segment.

4. The hole punch of claim 1, wherein the L shape handle includes sheet metal.

5. The hole punch of claim 1, wherein the cutting pin includes a radially facing notch proximate one end of the cutting pin that receives therein an actuating end of the short torque arm.

6. The hole punch of claim 1, wherein L shape arm is integral and directly linked to the cutting pin without discrete, intervening linkages.

7. The hole punch of claim 1, wherein the long lever arm of the handle includes a length that extends substantially from the front end to the back end of the base.

8. The hole punch of claim 1, wherein the punch element includes a torsion spring urging the cutting pin away from the slot holding the sheet media.

9. The hole punch of claim 1, wherein the long lever arm extends at least partially underneath the punch element.

10. A hole punch for punching a hole in sheet media, comprising:
a base having a front end and a back end;
at least two punch elements having a translating cutting pin, disposed overlying the base toward the front end and having a substantially upward opening slot for holding the sheet media therein;
a handle having an L shape profile wherein the handle pivots on the base corresponding the elbow in the L where the pivot is proximate the front end, and the handle having a short torque arm extending from the pivot to the cutting pin, and a long lever arm extending at least partially underneath the punch element having a pressing area at a distal end thereof; and
wherein the handle extends in between the at least two punch elements.

11. The hole punch of claim 10, wherein the pressing area of the long lever arm substantially overlies the back end of the base and a range of motion of the pressing area spans at least from above to below the height of the cutting pin longitudinal axis.

12. The hole punch of claim 10, wherein the base includes a groove to receive at least a portion of the long lever arm in its downward stroke.

13. The hole punch of claim 10, wherein a profile of the long lever arm is defined by a concave section adjacent the pivot and a convex section adjacent the pressing area.

14. A hole punch for punching a hole in sheet media, comprising:
a base having a front end and a back end;
a punch element having a translating cutting pin, disposed overlying the base and having a substantially upward opening slot for holding the sheet media therein;
a handle hinged at the front end of the base, wherein the handle includes an L shape profile with the hinge at one end and a pressing area at an opposite end that does not extend at its highest-most position above the height of the punch element, and further includes an axle coinciding with the hinge having a radially extending torque arm that engages the cutting pin; and
wherein the handle has a length that at least extends substantially the length of the base.

15. The hole punch of claim 14, wherein the axle and pressing area are parallel and disposed proximate to the base front end and the base back end, respectively, and the handle includes at least two connecting arms extending along respective sides of the base so that the axle, pressing area, and connecting arms substantially circumscribe the punch element.

16. The hole punch of claim 14, wherein the connecting arm and torque arm are parallel and not co-linear.

17. The hole punch of claim 14, wherein connecting arm includes an inverted L shape hinged at one end of the L.

18. The hole punch of claim 14, wherein the pressing area of the handle extends past the back end of the base.

19. A hole punch for punching a hole in sheet media, comprising:
means for punching a hole in sheet media having a slot for receiving the sheet media therein;
a base having a centerline dividing the base into a front half with a front end and a back half with a back end, wherein the means for punching is disposed overlying the front half of the base;
a handle passing in between the means for punching and the base, wherein the handle is pivoted on the base proximate to the front edge and extends to proximate the back edge terminating at a pressing end; and
a torque arm extending from the pivot of the handle and engaging the means for punching.

20. The hole punch of claim 19, wherein the handle include opposed curves and the base includes a recess to at least partially receive the handle.

21. A hole punch for punching a hole in sheet media, comprising:
at least two spaced-apart means for punching a hole in sheet media each having a slot for receiving the sheet media therein;
a base having a centerline dividing the base into a front half with a front end and a back half with a back end, wherein the means for punching is disposed overlying the front half of the base;
a handle passing in between the means for punching, wherein the handle is pivoted on the base proximate to the front edge and extends to proximate the back edge terminating at a pressing end; and
a torque arm extending from the pivot of the handle and engaging the means for punching.

22. The hole punch of claim 21, wherein the slot substantially opens upward.

23. A hole punch for punching a hole in sheet media, comprising:
means for punching a hole in sheet media having a substantially upward opening slot for receiving the sheet media therein;
a base having a centerline dividing the base into a front half with a front end and a back half with a back end, wherein the means for punching is disposed overlying the front half of the base;
the handle is pivoted on the base proximate to the front edge and extends to proximate the back edge terminating at a pressing end;
two connectors of the handle extending between the pivot and the pressing end, the connectors crossing to each side of the slot; and
a torque arm extending from the pivot of the handle and engaging the means for punching.
